(19) United States
(12) Patent Application Publication
(10) Pub. No.: US 2004/0246907 A1
(43) Pub. Date: Dec. 9, 2004

(54) Method for determining the propagation delay of a connection with transmission via a packet-based network

(76) Inventor: Klaus Hoffmann, Munchen (DE)

Correspondence Address: Siemens Corporation, Intellectual Property Department, 170 Wood Avenue South, Iselen, NJ, 08830, US

(21) Appl. No.: 10/490,425

(22) PCT Filed: Aug. 30, 2002
(86) PCT No.: PCT/DE02/03203

(30) Foreign Application Priority Data
Sep. 25, 2001 (DE) 101-47-164.5

(51) Int. Cl. H04L 12/56

(52) U.S. Cl. 370/252; 370/395.21; 370/519

(57) ABSTRACT

The invention relates to a method for determining the propagation delay in a packet-based network for a packet-based network section of a connection between terminals, at least sections of the connection being routed via the packet-based network. According to the inventive method, the broadcast relay in the packet-based network is determined for the packet-based network section of the connection and substantially half of the time period that has been determined for the broadcast relay is taken as a value for the propagation delay of the packet-based network section. The method permits the determination of the propagation delay in the packet-based network. This parameter can help, for example, to determine whether an echo compensation is required during a voice connection.

The invention relates to a method for determining the propagation delay in the packet network for a packet network section of a connection.

In circuit-switched telephony, also referred to by the acronym PSTN (public switched telephone network), subscribers of the public telephone network are connected to the switching systems of the public switching technology assigned to them or responsible for them. Using subscriber access concentrators or subscriber access networks, frequently just referred to as access networks, located upstream of the switching system, the subscriber accesses can be merged together but the result of this however is the sill circuit-based access by the switched subscribers to the switching system. The merging of the subscriber accesses is generally implemented using Time Division multiplexing—frequently abbreviated to TDM—for example PCM (Pulse Code Modulation) or SDH (Synchronous Digital Hierarchy).

With more recent telecommunication networks such as ISDN (Integrated Services Digital Network) or GSM (Global System for Mobile Communications) payload information and control information is transmitted separately within the framework of what is known as Signalling System No. 7 (SS#7 protocol). The SS#7 protocol is currently based on a 4-layer model with three layers the same for all applications for data transport and one layer for user-specific functions. This is also referred to as Message Transfer Parts (MTP, lower layer) and User Parts (UP, upper layer). Within the framework of the User Parts, for ISDN networks the ISDN User Part (ISUP) is defined for the use of services and service features which are the result of integration of telephone and data services. With the ISUP control information for setting up, clearing down and monitoring of circuit switched connections is a transferred for the transmission of payload information.

In TDM networks which operate with the ISUP protocol a parameter PD (Propagation Delay) is defined which defines a measure for the delay time of payload data transmitted for a connection. These parameters for propagation delay supply the criterion for deciding whether echo compensation must be switched into the connection and during connection setup whether specific routes may be used for the further connection setup. In this case each section of the connection delivers a fixed, known contribution to the propagation delay.

Within the context of increasing services which are based on variable bit rates the subscribers of the public telephone network increasingly have access to packet networks, namely access to the Internet via broadband transmission networks such as LANs (Local Area Networks), networks based on DSL (Digital Subscriber Line) technology or cable networks. For subscribers with access to a packet network the obvious course is to use the lines or networks necessary for packet-based access for telephone traffic as well, instead of maintaining separate narrow band lines/networks.

In adapting packet networks for telephony the attempt is made to make the performance and service features of PSTN networks available to subscribers where possible. The problem which arises here is that with a connection which is routed at least partly via a packet switched network, the packet network makes a contribution to the packet delay for which no figures are known.

The object of the invention is to specify a method for determining the propagation delay in the packet network.

The object is achieved by a method corresponding to the preamble of claim 1 by its identifying features.

In the method in accordance with invention a round trip delay in the packet network for the packet network section of the connection is determined and essentially half of the duration determined for the round trip delay is taken as a value for the propagation delay of the packet network section (claim 1). The method allows the propagation delay to be determined in the packet network. With the aid of this parameter it can for example be determined whether echo compensation is necessary for a voice connection.

The propagation delay for an embodiment of the method in accordance with invention is determined as part of the connection setup. The connection setup here is implemented with the aid of a connection setup message. The connection setup message triggers the determining of the propagation delay (claim 2). The propagation delay is determined during the connection setup. It allows possible settings to be made to improve or ensure quality which depend on the propagation delay before the payload data is transmitted. With a connection setup message containing a propagation delay parameter the value of the propagation delay parameter will be increased by the value of the propagation delay determined for the packet network section (claim 3). This can be done by transmitting the connection setup message during connection setup to a control device and for the control device to trigger determination of the propagation delay. The forwarding of the connection setup message is halted until the value of the propagation delay is available and has been added to the value of the propagation delay parameter (claim 4).

For the case where a connection is set up for which payload data and control data are routed separately in the packet network the method in accordance with the invention can execute as follows: The connection setup message is transmitted within the framework of connection setup. Determining the propagation delay will be triggered by sending a message to a gateway device. The round trip delay for the packet network section is determined by the gateway device and the value for the round trip delay or of the propagation delay determined for it is transmitted to the control device (claim 5).

Further advantageous developments of the inventive object are specified in the other subclaims.

The inventive object is explained below in more detail on the basis of an exemplary embodiment. The drawings show

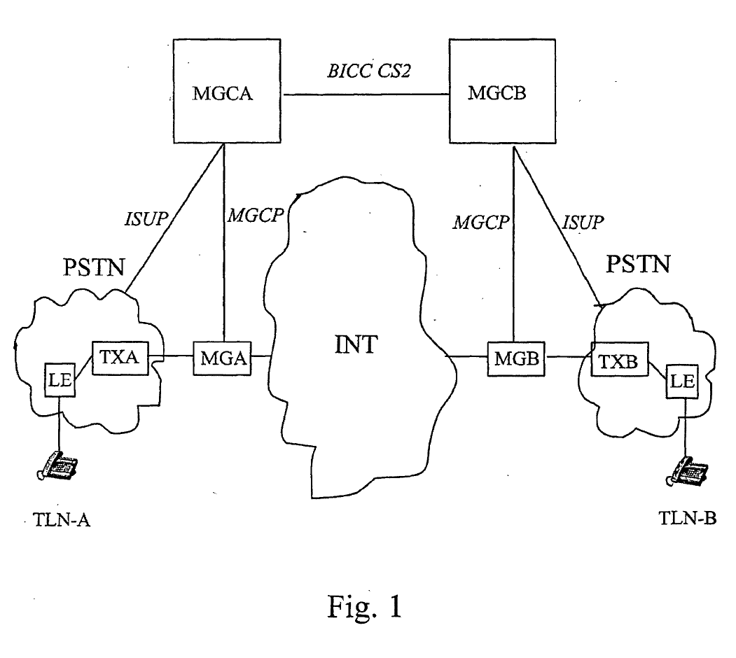

FIG. 1: System for a connection routed via a packet network from PSTN subscribers with separate transmission of signalling and payload data

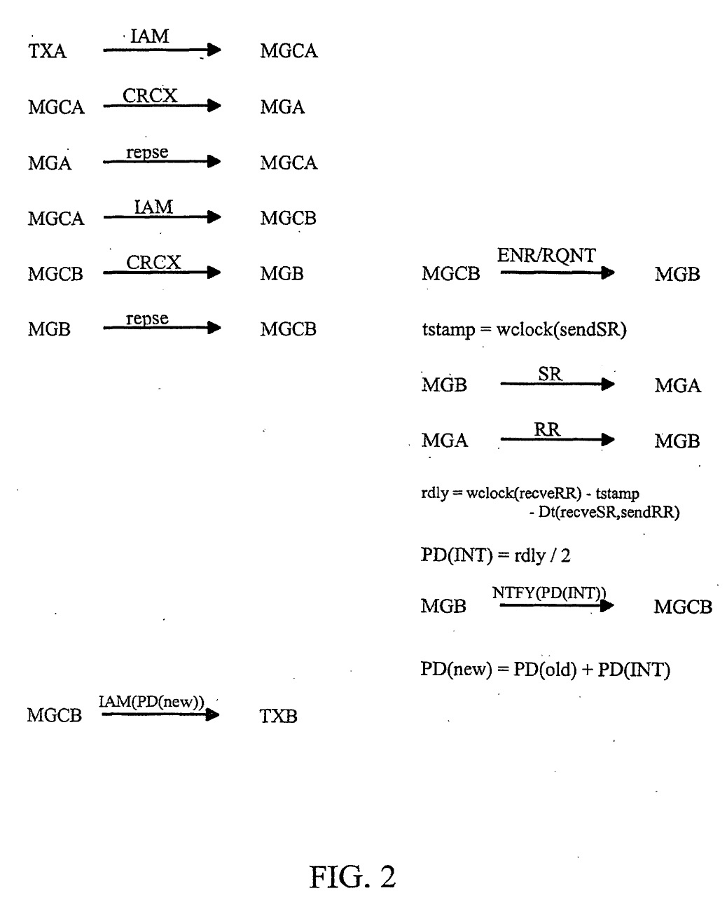

FIG. 2: Execution sequences of the method in accordance with the invention when the propagation delay is determined for the packet network section during the connection setup

The method in accordance with the invention will be illustrated on the basis of a connection initiated by a PSTN terminal TlnA with a second PSTN terminal TlnB. The connection is routed in sections over a packet network INT, for example the Internet, an Intranet or a network based on the ATM (Asynchronous Transfer Mode) technology. This can involve a telephone call for example. In detail the connection setup can be completed on the basis of FIG. 1. As the part of the connection payload information and control information is routed separately. The payload data is transmitted from the terminal TlnA to the local exchange LE and from there to the transit exchange TXA. The transit exchange TXA is connected to a network access device MGA (MG: for Media Gateway) which is provided for processing of the TDM payload data for transmission over a packet network INT. Payload data transmitted over the packet network INT as part of a speech application is again processed on the receiver side by a network access element MGB, to then be transmitted over a TDM network first to a transit exchange TXB and finally to a local exchange LE and to the terminal TlnB. Signaling data for setting up a connection on the other hand is transferred to the control unit MGCA (MGC for Media Gateway Controller) which is assigned to the media gateway MGA. This control unit can for example be a switching system or what is known as a gatekeeper. To control the connection setup control unit MGCA communicates with the media gateway MGA and the B-side control unit MGCB. Correspondingly for connection control the control unit MGCB exchanges messages with the control unit MGCA, the media gateway MGB and the receiver-side PSTN network. For the route between the calling subscriber TlnA and the media gateway MGA as well as for the route between the media gateway MGB and the call recipient TlnB the propagation delay can be obtained using known methods. In accordance with the invention the propagation delay between the media gateway MGA and the media gateway MGB is determined so that, together with the propagation delays for the other routes, the overall propagation delay for the connection of subscribers TlnA and TlnB can be determined. The setup of a connection is described for example in the ITU Standard Q.1902.4 corresponding to the protocol BICC CS2 (Bearer independent call control protocol capability set 2).

In FIG. 2 the exchange of messages for a typical connection setup is shown on the left-hand side. The connection setup message IAM (IAM: Initial Address Message) plays a central role in setting up a connection. To setup the connection over the packet network the transit exchange TXA sends an initial address message IAM to control unit MGCA. The receipt of the initial address message IAM at control unit MGCA triggers the sending of a message CRCX (CRCX: Create Connection) to the media gateway MGA which signals the request for setting up a connection. The receipt of this message CRCX is acknowledged by the media gateway MGA to the control unit MGCA by means of a response message recpt. The control unit MGCA then transfers the initial address message IAM to the control unit MGCB. On receiving the initial address message IAM the control unit MGCB sends a message CMCX to the media gateway MGB which signals the request to set up a connection. The receipt of this message is acknowledged by the media gateway MGB to the control unit MGCB. After receipt of the acknowledgement the initial address message IAM will be forwarded by the control unit MGB to the receiver-side transit exchange TXB. To complete the connection setup further control or response messages, for example in accordance with Q.1902.4, are transmitted. For the exchange of messages between the transit exchanges TXA and TXB and the control units MGCA and MGCB the ISUP protocol will be used. For signalling between the two control elements MGCA and MGCB a proprietary expanded ISUP protocol or the BICC protocol can be used. For the exchange of control information between the control elements MGCA and MGCB and the media gateways assigned to them MGA and MGB, the MGCP (MGCP: Media Gateway Control protocol) can be used. In accordance with the protocols used the initial address message IAM includes a parameter for the propagation delay PD (PD: Propagation Delay). This parameter PD specifies the value of the propagation delay determined. When the initial address message IAM was transferred to the control element MGCA the value of the propagation delay parameter PD corresponds to the propagation delay determined on a caller side for the route in the PSTN network. For the transmission of the initial address message IAM from the control element MGCA to the control element MGCB the value of the propagation delay does not change. In accordance with the invention the control element MGCB, when the initial address message IAM arrives, triggers the determining of the propagation delay by transmission over the packet network. The additional processes running during connection setup to determine the propagation delay are shown in FIG. 2 on the right hand side. The control element MGCB sets up a connection with this media gateway MGCB by transmitting the message CRCX to the media gateway MGB. In addition, with a message ENR (ENR: Encapsulated Notification Request) or by a Notification Request RQNT command the determination of a propagation delay in the packet network PD(INT) is requested by the media gateway MGB. On receipt of this message the round trip delay rdly for the transmission to the media gateway MGA is determined by the media gateway MGB. Half of the round trip delay rdly determined is taken as the propagation delay PD(INT) for the transmission over the packet network. The propagation delay PD(INT) over the packet network is transmitted to the control element MGCB and added to the value of the propagation delay parameter of the initial address message IAM. The transmission of the initial address message IAM to the receiver side transit exchange TXB is delayed until the propagation delay over the packet network has been determined and propagation delay parameter PD of the initial address message IAM has been correspondingly increased. (shown in FIG. 2 by the equation PD(new)=PD(old)+PD(INT).) The connection setup can now be continued as originally intended.

The calculation of the round trip delay for a packet oriented network is described for example in the draft standard RFC 1889, Section 6.3, of the IAB (Internet Architecture Board) and is sketched out below. Within the framework of the RTCP protocol, the RTC control protocol, packets are defined for (SR: sender report) messages and (RR: receiver report) messages. For the SR and RR packets time stamps (tstamp: for timestamp) are defined as parameters, which are given the value of the send time of the relevant send clock wclock(sendSR) (wclock: for wallclock) of the packet. This means that the sender is equipped with a timing function with time measurement (wallclock time), which for example records the (absolute) operating time of the sender. In the calculation of the round trip delay rdly the sender sends a sender report message packet SR with the corresponding time stamp wclock(sendSR). The receiver extracts from the sender report message packet SR the corresponding time stamp wclock(sendSR) and sends a receiver report message packet RR. This receiver report message packet RR contains the time stamp wclock(sendSR) of the sender report message packet SR and the time difference Dt(recveSR,sendRR) between sending the receiver report message packet RR and the arrival of the sender report message packet SR. at the sender, i.e. the media gateway MGB will calculate the round trip delay after the arrival of the receiver report message packet RR, by subtracting the time of the arrival wclock(recveRR) of the receiver report message packet RR from the time stamp tstamp of the sender report message packet SR and the time difference between arrival of the receiver report message packet and the sending of the sender report message packet Dt(recveSR,sendRR).

1-12. (canceled)

13. A method for determining the propagation delay in the packet network for a packet network section of a connection between terminals in the course of a connection setup with the aid of a propagation delay parameter contained in an initial address message, comprising:
transmitting the initial address message;
determining the propagation delay triggered by the initial address message;
determining the round trip delay in the packet network for the packet network section of the connection;
taking half of the duration determined for the round trip delay as a value for the propagation delay of the packet network section; and
incrementing the value of the propagation delay parameter by the value of the propagation delay of the packet network section.

14. The method in accordance with claim 13, wherein the initial address message is transmitted within the framework of connection setup to a control device, the control device is triggered from the determination of the propagation delay, and the onward transmission of the initial address message is stopped until the value of the propagation delay is available and has been added to the value of the propagation delay parameter.

15. The method in accordance with claim 13, wherein a connection is set up in which payload and control information are routed separately in the packet network, the initial address message is transmitted as part of the connection setup to a control unit, the determining of the propagation delay is triggered by the sending of a message to a media gateway, the round trip delay is determined for the packet network section by the media gateway, and the value for the round trip delay or for the propagation delay determined is transferred to the control unit.

16. The method in accordance with claim 13, wherein the initial address message is transmitted with the aid of an ISUP protocol adapted for transmitting payload data over a packet network or with the aid of the BICC protocol.

17. The method in accordance with claim 13, wherein the sending of the message to the media gateway and the transfer of the value for the round trip delay or for the propagation delay determined is transmitted to the control unit with the aid of an MGCP protocol adapted for these functions.

18. The method in accordance with claim 17, wherein the message is transmitted to the media gateway as an embedded proprietary information element.

19. The method in accordance with claim 17, wherein the propagation delay in the packet network is determined for a packet network section for which there is provision for the transmission of payload data with the aid of an Internet protocol and the protocol, with an additional function being provided in the RTP protocol for initiating the determination of the propagation delay or for determining the round trip delay.

20. The method in accordance with claim 13, wherein the propagation delay in the packet network is determined for a packet network section within the context of a connection with speech transmission over the packet network.

21. The method in accordance with claim 13, wherein the round trip delay is determined with the aid of the exchange of messages between two media gateways, with the two media gateways connecting the packet network to the PSTN network.

22. The method in accordance with claim 13, wherein at least some sections of the connection are routed via the packet network.
